(19) United States
(12) Patent Application Publication
(10) Pub. No.: US 2011/0255705 A1
(43) Pub. Date: Oct. 20, 2011

(54) INFORMATION SYSTEM AND OPERATIONAL NOISE CANCELING METHOD

(75) Inventor: Tsuyoshi OZEKI, Nagoya-shi (JP)

(73) Assignee: BUFFALO INC., Nagoya-shi (JP)

(21) Appl. No.: 13/088,421

(22) Filed: Apr. 18, 2011

(30) Foreign Application Priority Data
Apr. 19, 2010 (JP) 2010-095659

(51) Int. Cl. G10K 11/16

(52) U.S. Cl. 381/71.3; 381/71.1

(57) ABSTRACT

Provided is an information system including an information processing device having an audio output function, and a peripheral device connected to the information processing device. The information processing device includes: a device specifying section for designating the peripheral device; a data obtaining section for obtaining, based on designation results from the device specifying section, operational noise cancellation data being audio data for cancelling operational noise emitted from the peripheral device; and an operational noise canceling section for outputting, by means of the audio output function, the operational noise cancellation data obtained by the data obtaining section.

### CROSS REFERENCE TO RELATED APPLICATION

The disclosure of Japanese Patent Application No. 2010-095659 filed on Apr. 19, 2010 is incorporated herein by reference.

### BACKGROUND OF THE INVENTION

1. Field of the Invention

The present invention relates to noise cancellation generally, and more specifically to noise cancellation methods and devices enabling the methods, in information systems having data-processing and audio-output functions and involving peripheral devices.

2. Description of the Background Art

Techniques for reducing operational noise emitted from rotating equipment such as HDDs or heat-dissipating fans built into devices having an audio output function, have been disclosed (reference is made to Japanese Laid-Open Patent Publication No. 2004-4229, for example). The disclosed technique cancels operational noise from the rotating equipment built into the device. In the disclosed technique, the device stores in advance, in its own storage means, noise cancellation data appropriate to the rotating equipment built into the device. When the rotating equipment is operated, the device reads the noise cancellation data from the storage means, and superimposes the noise cancellation data on audio data to cancel the operational noise.

In the disclosed technique, however, the noise cancellation data stored in the storage means is data that is specific to the operational noise emitted from the rotating equipment already built into the device. Therefore, although the effect of canceling operational noise from HDDs, heat-dissipating fans, and other rotating equipment already built into the device can be expected, it is not possible to cancel operational noise from rotating equipment, such as HDDs, DVD players, or other equipment including movable components, included in peripheral devices externally connected to the main device. The reason is because the main device is not provided with noise cancellation data corresponding to the operational noise from the rotating equipment built into the externally connected peripheral device.

### SUMMARY OF THE INVENTION

Therefore, an object of the present invention is to provide a device having an audio output function, which can cancel operational noise emitted from a peripheral device connected thereto.

A first aspect of the present invention is directed to an information system including an information processing device having an audio output function, and a peripheral device connected to the information processing device. The information processing device includes: a device specifying section for designating the peripheral device; a data obtaining section for obtaining, based on designation results from the device specifying section, operational noise cancellation data being audio data for cancelling operational noise emitted from the peripheral device; and an operational noise canceling section for outputting, by means of the audio output function, the operational noise cancellation data obtained by the data obtaining section.

The peripheral device preferably includes a storage section, and the operational noise cancellation data preferably includes audio data for canceling operational noise from the storage section.

The peripheral device preferably includes a cooling fan, and the operational noise cancellation data preferably includes audio data for canceling operational noise and/or wind noise from the cooling fan.

The peripheral device preferably has first identification information for identifying the peripheral device, and the device specifying section preferably includes a reading section for reading the first identification information from the peripheral device, and designates the peripheral device based on the first identification information.

The information processing device or the peripheral device preferably stores a plurality of items of operational noise cancellation data, and the data obtaining section includes a selection section for selecting, from the plurality of items of operational noise cancellation data, operational noise cancellation data corresponding to operational noise emitted from the peripheral device.

The data obtaining section preferably includes a selection section for selecting, from an external storage section storing a plurality of items of operational noise cancellation data, via a network, operational noise cancellation data corresponding to operational noise emitted from the peripheral device.

The reading section preferably obtains, from the peripheral device, second identification information for identifying the operational status of the peripheral device, and the data obtaining section preferably selects, based on the first and second identification information, operational noise cancellation data corresponding to operational noise emitted from the peripheral device.

The peripheral device preferably includes a storage section, and the second identification information is preferably information identifying the state of access to the storage section.

A second aspect of the present invention is directed to, for an information system including an information processing device having an audio output function and a peripheral device connected to the information processing device, a computer-readable non-transitory storage medium storing a program that causes a processor of the information processing device to execute the steps of: obtaining, from the peripheral device, first identification information for identifying the peripheral device; obtaining, based on the first identification information, operational noise cancellation data as audio data for canceling operational noise emitted from the peripheral device; and outputting, by means of the audio output function, the obtained operational noise cancellation data.

The operational noise cancellation data obtaining step that the recording medium causes the processor to execute preferably includes a substep of selecting, from a plurality of items of operational noise cancellation data stored in the information processing device or the peripheral device, operational noise cancellation data corresponding to the first identification information.

The operational noise cancellation data obtaining step that the recording medium causes the processor to execute preferably includes substeps of: accessing, via a network, an external storage section storing a plurality of items of operational noise cancellation data; and selecting, from the external storage section, operational noise cancellation data corresponding to the first identification information.

The program preferably causes the processor of the information processing device to further execute the steps of: causing a processor of the peripheral device to detect a change in the operational status of the peripheral device; causing the processor of the peripheral device to transmit to the information processing device, when change in the operational status is detected, second identification information for identifying the changed operational status; and obtaining the second identification information. The operational noise cancellation data obtaining step is preferably a step of obtaining operational noise cancellation data for canceling operational noise from the peripheral device, based on the second identification information as well as the first identification information.

A third aspect of the present invention is directed to, for an information system including an information processing device having an audio output function and a peripheral device connected to the information processing device, an operational noise canceling method to be executed by a processor of the information processing device. The method includes the steps of: obtaining first identification information identifying the peripheral device; obtaining, based on at least the first identification information, operational noise cancellation data as audio data for canceling operational noise emitted from the peripheral device; and outputting, by means of the audio output function, the obtained operational noise cancellation data.

According to the present invention, in an information system in which a peripheral device is externally connected to an information processing device having an audio output function, canceling noise data for canceling operational noise emitted from the peripheral device can be obtained in accordance with the connected peripheral device. Therefore, the operational noise emitted from the connected peripheral device can be canceled regardless of the type of the peripheral device, and regardless of before or after the time when the peripheral device is connected.

The present invention is applicable to, for example, a common information system in which a peripheral device is externally connected to a personal computer used at home or office. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit block diagram illustrating an information system according to Embodiment 1 of the present invention;

FIG. 2 is a flowchart illustrating a process of canceling operational noise from a peripheral device in the information system according to Embodiment 1 of the present invention;

FIG. 3 is a circuit block diagram illustrating an information system according to Embodiment 2 of the present invention;

FIG. 4 is a circuit block diagram of an information system according to a first modification of Embodiment 2 of the present invention;

FIG. 5 is a circuit block diagram of an information system according to a second modification of Embodiment 2 of the present invention; and

FIG. 6 is a flowchart illustrating a process of canceling operational noise from a peripheral device in the information system of Embodiment 2 of the present invention.

### DESCRIPTION OF THE PREFERRED EMBODIMENTS

### Embodiment 1

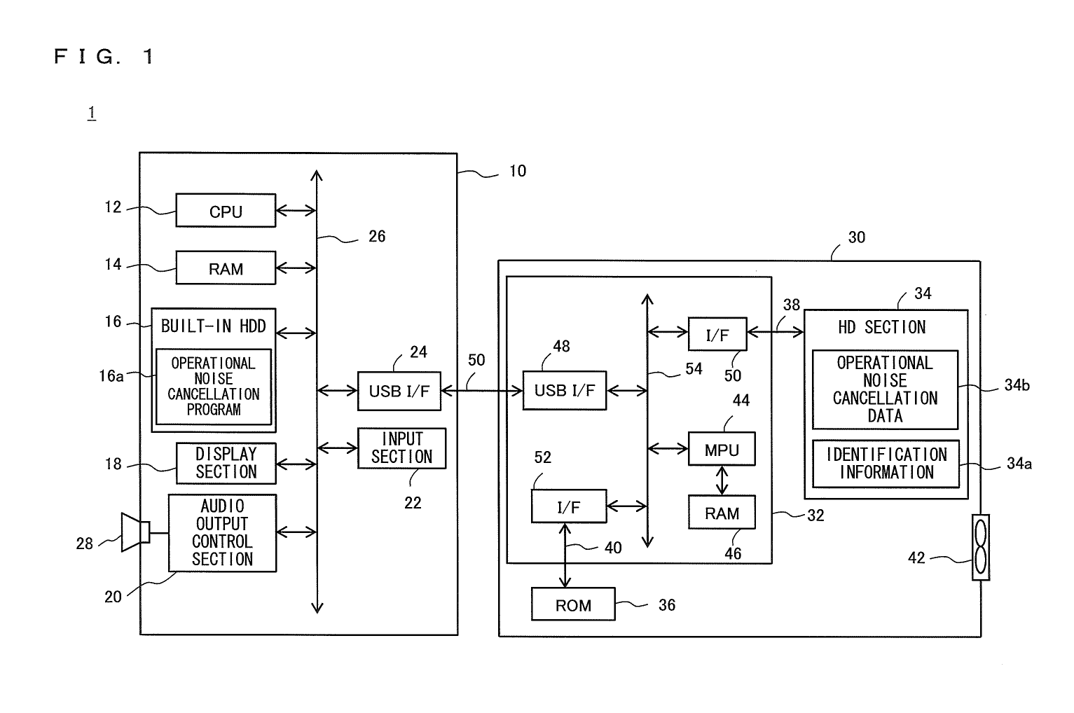

FIG. 1 is a block diagram exemplifying an information system 1 according to Embodiment 1 of the present invention. The information system 1 is of a configuration in which an external hard disk drive (abbreviated as external HDD, hereinafter) 30 as an external storage device is connected to a personal computer (abbreviated as PC, hereinafter) 10 via a USB cable 50. The information system 1 exemplifies a configuration in which the external HDD 30 as an external peripheral apparatus is connected to a personal computer commonly used by individuals or in an office or the like.

The configuration of the PC 10 will be described. The PC 10 includes a central processing unit (abbreviated as CPU, hereinafter) 12 as a processor, a random access memory (abbreviated as RAM, hereinafter) 14, a built-in hard disk drive (abbreviated as built-in HDD, hereinafter) 16, a display section 18, an audio output control section 20, an input section 22, and an USB interface (abbreviated as USB I/F hereinafter) 24. These components are connected to each other via an internal bus 26. A speaker 28 is connected to the audio output control section 20.

In the present embodiment, as one example, an operational noise cancellation program 16a is stored in the built-in HDD 16 of the PC 10, and identification information 34a and operational noise cancellation data 34b for the external HDD 30 are stored in an HD section 34 of the external HDD 30. Accordingly, the operational noise cancellation program 16a is executed in the PC 10, and the operational noise cancellation data 34b is read from the external HDD 30, and thus canceling of operational noise is performed.

After booting, the CPU 12 loads, in the RAM 14, various kinds of programs stored in the built-in HDD 16 or the like, and executes the programs. Thus, the CPU 12 executes various kinds of data processing on data. The data to be subjected to the data processing are stored in the built-in HDD 16, or entered through the input section 22, or entered via the USB cable 50. The data may include audio data of a recorded television program or the like. The audio data is processed by the CPU 12 executing various kinds of application programs. The processed audio data is transmitted to the audio output control section 20 via the internal bus 26, and thus audio is outputted from the speaker 28.

The CPU 12 reads and activates the operational noise cancellation program 16a stored in the built-in HDD 16. The CPU 12 executes the operational noise cancellation program 16a to obtain operational noise cancellation data, which is audio data having phase characteristics that cancel operational noise emitted from the external HDD 30. The CPU 12 superimposes the obtained operational noise cancellation data on audio data that is obtained by data processing according to another program such as an application program, and transmits the resultant data to the audio output control section 20. Alternatively, the CPU 12 transmits the operational noise cancellation data to the audio output control section 20, and thereafter, controls the audio output control section 20 to superimpose the operational noise cancellation data on audio data obtained by data processing according to another program. From the speaker 28, audio, in which the operational noise cancellation data is superimposed on the audio data of the application, is outputted. Since the outputted operational noise cancellation data has phase characteristics that cancel the operational noise emitted from the external HDD 30, the operational noise cancellation data cancels the operational noise. Thereby, a user can listen the audio data with operational noise from the external HDD 30 being reduced. In this way, the CPU 12 controls the operations of the respective components of the PC 10, thereby controlling the overall operation of the PC 10.

The input section 22 receives operational commands to the PC 10, each program's activation command , and various commands and data which are required in data processing by the programs. For example, the input section 22 is an input device such as a keyboard or a mouse. The display section 18 is a display device such as a monitor, and functions as an operation screen of the PC 10 or a monitor for video data. The USB I/F 24 is a device that functions as an interface for controlling communication using the USB cable 50.

The external HDD 30 includes, for example, a control section 32, a hard disk drive section (abbreviated as HD section, hereinafter) 34, and a nonvolatile read-only memory (abbreviated as ROM, hereinafter) 36. The control section 32 and the HD section 34 are connected to each other by an internal bus 38, and the control section 32 and the ROM 36 are connected to each other by an internal bus 40. The external HDD 30 further includes a cooling fan 42.

The control section 32 includes a microprocessing unit (abbreviated as MPU, hereinafter) 44 as a processor, a USB I/F 48, and bus interfaces (abbreviated as bus I/Fs hereinafter) 50 and 52 with the buses 38 and 40, respectively. These components are connected to each other by an internal bus 54. A RAM 46 is connected to the MPU 44.

The HD section 34 is configured with a disk-type recording medium (not shown) in which data are stored. The recording medium rotates during data writing and reading. Drive noise associated with the rotation of the recording medium is the operational noise from the external HDD 30.

The identification information 34a for identifying the external HDD 30 and the operational noise cancellation data 34b is stored in the HD section 34. Further, various kinds of programs for driving and controlling the external HDD 30 are stored in the HD section 34 or the ROM 36.

When, for example, the external HDD 30 is powered on, the MPU 44 reads a program from the HD section 34 (the ROM 36) via the internal bus 38 and the I/F 50 (the internal bus 40 and the IF 52), and the internal bus 54, and executes the program. Thereby, the external HDD 30 is booted, and becomes accessible from the PC 10 via the USB cable 50. In this way, the MPU 44 controls the operations of the respective components of the external HDD 30, thereby controlling the overall operation of the external HDD 30.

The cooling fan 42 is a fan for heat dissipation/cooling of the inside of the external HDD 30. The cooling fan 42 is powered by a supply circuit (not shown) or controlled by the MPU 44 via a signal path (not shown), and thereby blows air for heat dissipation/cooling into the inside of the external HDD 30. Drive noise and/or wind noise associated with rotation of the cooling fan 42 are also included in the operational noise from the external HDD 30.

The operational noise cancellation data 34b is data corresponding to the operational noise emitted from the external HDD 30. The external HDD 30 sets up operational noises including drive noise associated with rotation of the disk-type recording medium in the HD section 34, and drive noise and/or wind noise associated with rotation of the cooling fan 42. The operational noise cancellation data 34b is audio data that cancels the operational noise comprising the drive noise associated with rotation of the disk-type recording medium in the HD section 34, and the drive noise and/or wind noise associated with rotation of the cooling fan 42. The drive conditions under which the recording medium or the cooling fan in the HD section 34 are spun differ depending on the operational status of the external HDD 30—for example, the access state—writing, reading, idling, etc.—of the HD section 34. Consequently, unique operational noises are generated depending on the different operational statuses. Accordingly, one or more types of operational noise cancellation data 34b are provided to correspond to the operational statuses.

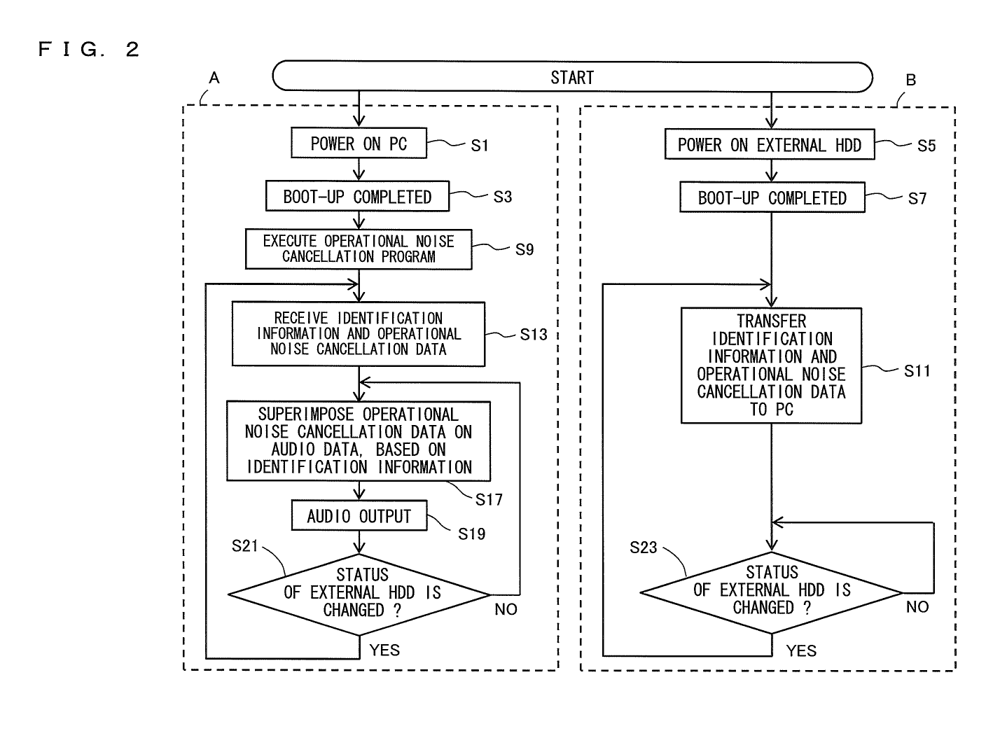

FIG. 2 shows the flow of a process for canceling the operational noise from the external HDD 30. In FIG. 2, (A) shows a process flow executed by the CPU 12 in the PC 10, and (B) shows a process flow executed in the external HDD 30. The processes in the external HDD 30 shown in (B) are executed based on commands from the CPU 12 in the PC 10.

When the PC 10 is powered on (step S1), the CPU 12 initializes the respective components of the PC 10, and boots the PC 10. When booting is completed (step S3), the CPU 12 loads the operational noise cancellation program 16a from the built-in HDD 16 to the RAM 14, and executes the program 16a (step S9). By thereafter, executing the operational noise cancellation program 16a, which is resident in the RAM 14, the CPU 12 repeats the following processes.

When the CPU 12 detects that the external HDD 30 is powered on (step S5) and booting is completed (step S7), the CPU 12 obtains, from the external HDD 30, the identification information 34a and the operational noise cancellation data 34b that accords with the operational status of the external HDD 30, which are stored in the HD section 34 (step S11).

When the CPU 12 receives the transmitted identification information 34a and the operational noise cancellation data 34b (step S13), the CPU 12 superimposes the operational noise cancellation data 34b onto audio data of an ordinary application, based on the identification information 34a (step S17).

The identification information 34a is information for identifying the external HDD 30. Even with the same operational status, it might be necessary to adjust the phase and/or the amplitude of the operational noise cancellation data 34b, depending on the specifications of the external HDD 30, such as the size of the casing of the external HDD 30, the mount positions of the HD section 34 and the cooling fan 42 in the casing, and the like. The CPU 12 identifies the external HDD 30 and, if necessary, adjusts the operational noise cancellation data 34b, based on the identification information 34a. The identification information 34a may include, in addition to the information for identifying the external HDD 30, other information to be used for adjusting the operational noise cancellation data 34b, such as information for identifying the current operational status of the external HDD 30.

The CPU 12 superimposes the operational noise cancellation data 34b on audio data obtained by data processing by another program such as an application program, and transmits the resultant data to the audio output control section 20. Alternatively, the CPU 12 may transmit the operational noise cancellation data 34b to the audio output control section 20, and thereafter, control the audio output control section 20 to superimpose the operational noise cancellation data 34b onto audio data obtained by data processing according to another program.

The superimposed audio data is outputted from the speaker 28 via the audio output control section 20 (step S 19). Then, canceling noise having phase characteristics that cancel the operational noise from the external HDD 30 is outputted from the speaker 28, and thus the operational noise is canceled such as to be unlikely for a user to hear.

The operational noise cancellation program 16a is resident in the RAM 14, and the CPU 12 continues to execute the program 16a. That is, the CPU 12 continues to monitor the operational status of the external HDD 30 (step S21, step S23). As described above, the operational status is, for example, the access state to the HD section 34 in the external HDD 30.

When the operational status is unchanged (NO in step S21, NO in step S23), the processes in steps S17 to S19 are executed every time audio data obtained by data processing by another application is outputted.

When it is detected that the operational status is changed (YES in step S21, YES in step S23), the CPU 12 returns to step S11 and step S13. The CPU 12 obtains the identification information 34a and the operational noise cancellation data 34b, which are stored in the HD section 34 (step S11, S13). In this case, the CPU 12 obtains the identification information 34a and the operational noise cancellation data 34b, which correspond to the changed operational status.

The CPU 12 repeats, in the PC 10, the processes in steps S17 to S19 based on the newly obtained identification information 34a and operational noise cancellation data 34b, and thus the audio data superimposing process is performed based on the newly obtained identification information 34a and operational noise cancellation data 34b.

### Embodiment 2

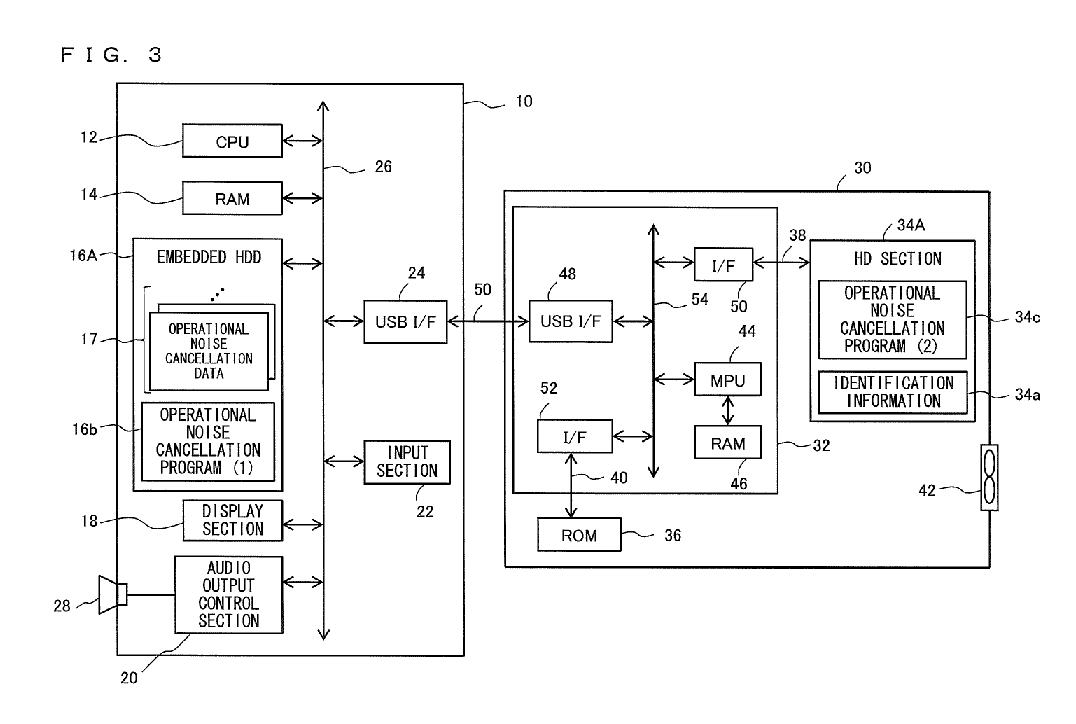

FIG. 3 is a circuit block diagram exemplifying an information system 2 according to Embodiment 2 of the present invention. The configuration of the information system 2 of Embodiment 2 is identical to that of the information system 1 of Embodiment 1 (FIG. 1) except that the PC 10 includes a built-in HDD 16A instead of the built-in HDD 16, and the external HDD 30 includes an HD section 34A instead of the HD section 34. In FIG. 3, the components denoted by the same reference numerals as those in FIG. 1 are identical to those of the information system 1 of Embodiment 1, and therefore, repeated description is not necessary.

In the built-in HDD 16A, an operational noise cancellation program (1) 16b is stored instead of the operational noise cancellation program 16a, and in addition, an operational noise cancellation data constellation 17 is stored. In the HD section 34A, an operational noise cancellation program (2) 34c is stored instead of the operational noise cancellation data 34b. In Embodiment 1, the operational noise cancellation data 34b is stored, as data specific to the external HDD 30, in the HD section 34. In the present embodiment, instead of the operational noise cancellation data 34b, an operational noise cancellation data constellation 17 is stored, as a library including a plurality of items of operational noise cancellation data, in the built-in HDD 16A of the PC 10.

In the present embodiment, the CPU 12 of the PC 10 executes the operational noise cancellation program (1) 16a, and the MPU 44 of the external HDD 30 executes the operational noise cancellation program (2) 34c. The CPU 12 of the PC 10 reads, based on the identification information 34a for the external HDD 30, the corresponding operational noise cancellation data from the operational noise cancellation data constellation 17, and performs canceling of the operational noise. Hereinafter, modifications of the present embodiment will be described.

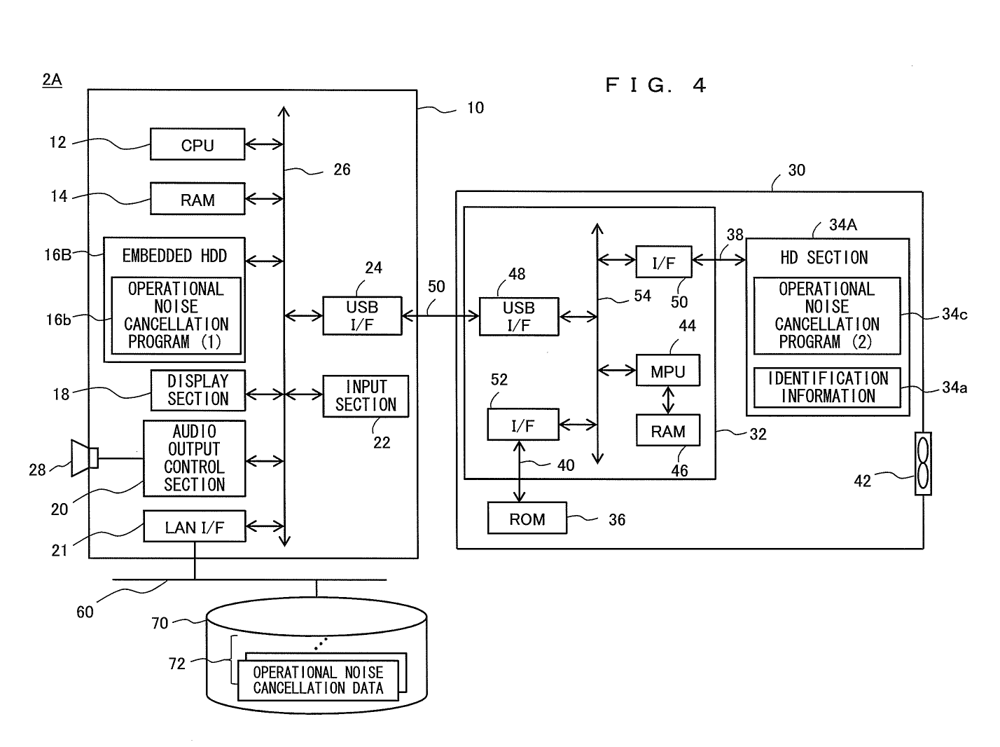

FIG. 4 is a circuit block diagram illustrating a first modification of the present embodiment. In FIG. 4, the components denoted by the same reference numerals as those in FIGS. 1 and 2 are identical to those of the information system 1 and the information system 2, and therefore, repeated description is not necessary.

In the information system 2A, the PC 10 includes a built-in HDD 16B instead of the built-in HDD 16A in the information system 2 (FIG. 3). The PC 10 further includes a LAN interface section (abbreviated as LAN I/F hereinafter) 21. The PC 10 is connected to a LAN 60 via the LAN I/F 21. An external data storage unit 70 is connected to the LAN 60. The external data storage unit 70 stores an operational noise cancellation data constellation 72 as a library including a plurality of items of operational noise cancellation data.

In this modification, the CPU 12 of the PC 10 executes the operational noise cancellation program (1) 16a, and the MPU 44 of the external HDD 30 executes the operational noise cancellation program (2) 34c. Based on the identification information 34a for the external HDD 30, the CPU 12 of the PC 10 accesses the LAN-connected external data storage unit 70, reads the corresponding operational noise cancellation data from the operational noise cancellation data constellation 72 stored in the external data storage section 70, and performs canceling of operational noise.

Since the operational noise cancellation data is read from the LAN-connected external data storage unit 70, the amount of data to be stored in the built-in HDD 16B is reduced, and the load in managing the operational noise cancellation data is reduced.

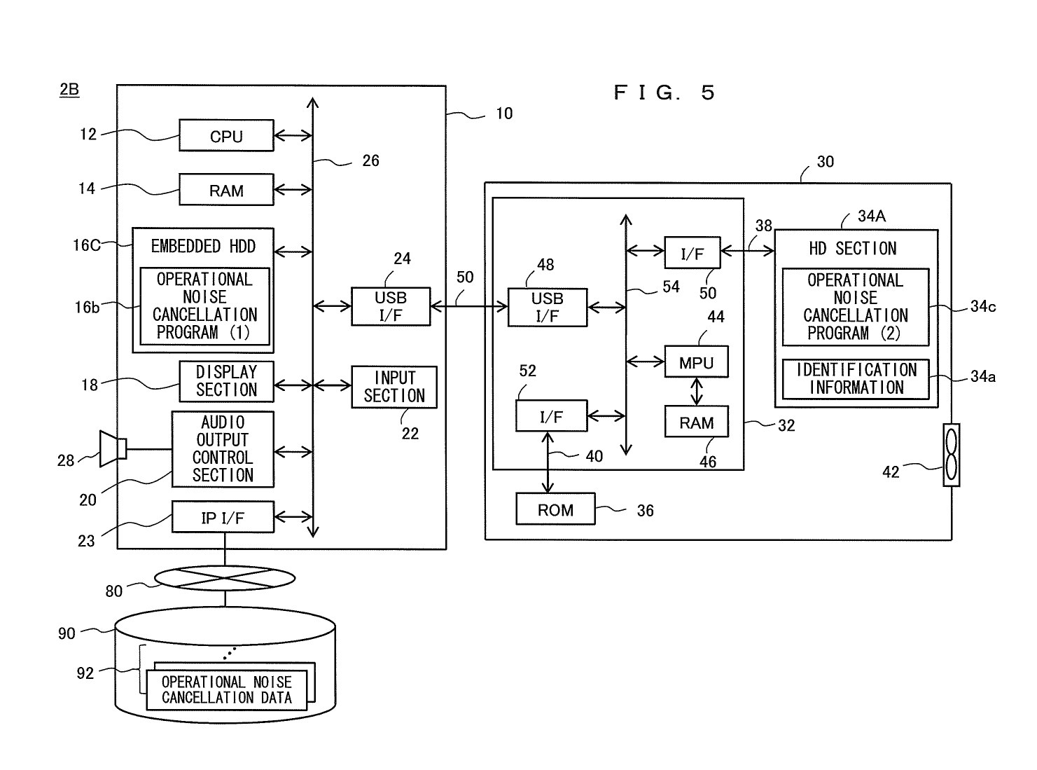

FIG. 5 is a circuit block diagram illustrating a second modification of the present embodiment. In FIG. 5, the components denoted by the same reference numerals as those in FIGS. 1, 3, and 4 are identical to those of the information system 1, the information system 2, and the information system 2A, and therefore, repeated description is not necessary.

In the information system 2B, the PC 10 includes a built-in HDD 16C instead of the built-in HDD 16A in the information system 2 (FIG. 3). The PC 10 further includes an internet protocol interface (abbreviated as IP I/F, hereinafter) 23 for connection to the Internet. The PC 10 is connected to the Internet 80 via the IP I/F 23. A data storage site 90 is connected to the Internet 80. The data storage site 90 stores an operational noise cancellation data constellation 92 as a library having a plurality of items of operational noise cancellation data.

In this modification, the CPU 12 of the PC 10 executes the operational noise cancellation program (1) 16a in the PC 10, and the MPU 44 of the external HDD 30 executes the operational noise cancellation program (2) 34c. Based on the identification information 34a of the external HDD 30, the CPU 12 of the PC 10 accesses the data storage site 90 connected to the PC 10 via the Internet 80, reads the corresponding operational noise cancellation data from the operational noise cancellation data constellation 92 stored in the data storage site 90, and performs canceling of operational noise.

The data storage site 90 is, for example, a website run by a vendor who provides the external HDD 30. By updating, as needed, the operational noise cancellation data constellation 92 in accordance with products released on the market, rapid response to the released product is realized.

With respect to the information systems 2, 2A, and 2B (FIGS. 3 to 5) described as modifications of the present embodiment, the process flow for canceling operational noise from the external HDD 30 will be described.

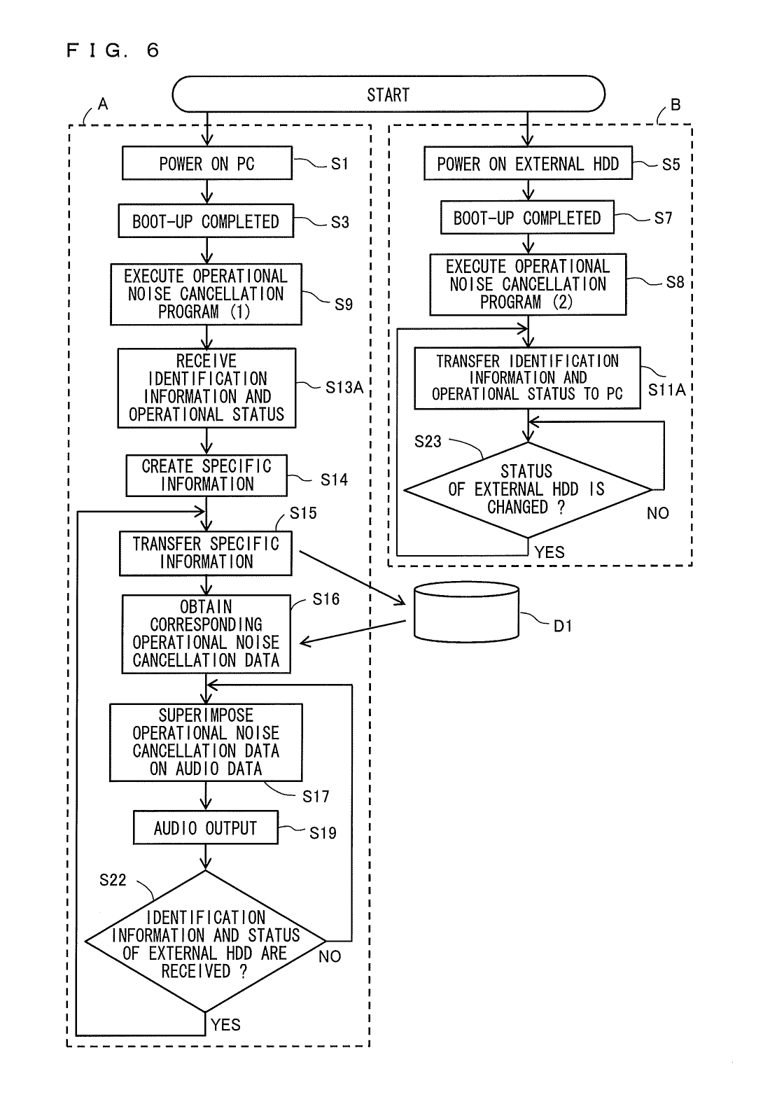

First, the information systems 2A and 2B will be described with reference to the process flow shown in FIG. 6. The process flow (A) in the PC 10 is obtained by replacing step S13 and step S21 in the process flow of Embodiment 1 (FIG. 2) with step S13A and step S22, respectively, and adding steps S14 to S16. The process flow (B) in the external HDD 30 is obtained by replacing step S11 in the process flow of Embodiment 1 (FIG. 2) with step S11A, and adding step S8. The steps denoted by the same reference numerals as those in FIG. 2 are identical to those of the process flow of Embodiment 1, and therefore, repeated description is not necessary. Hereinafter, only the steps different from those of the process flow of Embodiment 1 (FIG. 2) will be described.

In the present embodiment, the operational noise cancellation program (1) 16b is stored in the built-in HDDs 16A to 16C of the PC 10, and the operational noise cancellation program (2) 34c is stored in the HD section 34A of the external HDD 30. Accordingly, after booting of the PC 10 is completed (step S1, step S3), the operational noise cancellation program (1) 16b is loaded into the CPU 12 from the built-in HDDs 16A to 16C, and executed (step S9). After booting of the external HDD 30 is completed (step S5, step S7), the operational noise cancellation program (2) 34c is loaded from the HD section 34A to the MPU 44, and executed (step S8).

The processes in steps S11A and S23 in the external HDD 30 are performed by the operational noise cancellation program (2) 34c executed by the MPU 44. That is, after execution of the operational noise cancellation program (2) 34c is started (step S8), the MPU 44 transmits the identification information 34a and the operational status, which are stored in the HD section 34A, to the PC 10 (step S11A), in response to detection of a change in the operational status of the external HDD 30 (YES in step S23).

In the PC 10, after execution of the operational noise cancellation program (1) 16b is started (step S9), the CPU 12 receives the identification information 34a and the operational status (step S13A), which are transmitted from the external HDD 30 (step S11A). Then, the CPU 12 creates, based on the received information, specifying information for designating the external HDD 30 connected to the PC 10, and its operational status (step S14).

Then, the CPU 12 transmits the created specifying information to an external data storage section D1 (step S15). The “external data storage section D1” in the information system 2A (FIG. 4) is the external data storage unit 70, and in the information system 2B (FIG. 5) is the data storage site 90.

The external data storage unit 70 or the data storage site 90 selects, based on the specifying information, operational noise cancellation data. If it is possible to select the operational noise cancellation data based on the identification information 34a and the operational status in the external data storage unit 70 or the data storage site 90, the process in step S14 may be skipped, and the identification information 34a and the operational status may be transmitted as they are in step S15.

In step S16, the CPU 12 obtains, from the data storage section D1, the operational noise cancellation data corresponding to the external HDD 30 and its operational status.

After the CPU 12 obtains the operational noise cancellation data, the CPU 12 executes the processes in steps S17 to S19 as in the case of Embodiment 1 (FIG. 2), and outputs, from the speaker 28, audio including the canceling noise.

Step S22 is a step relating to a case where the identification information 34a and the operational status are transmitted to the PC 10 in response to detection of a change in the operational status in the external HDD 30 (YES in step S23). If no change in the operational status is detected in the external HDD 30, and therefore the identification information and the operational status are not received (NO in step S22), steps S17 to S19 are executed on the occasion of audio output by an ordinary application.

If a change in the operational status of the external HDD 30 is detected and therefore identification information and operational status are received (YES in step S22), the CPU 12 returns to step S14 to designate the external HDD 30 and its operational status, and thereafter repeats steps S15 to S19.

Next, the information system 2 (FIG. 3) will be described. The information system 2 is different from the information systems 2A and 2B in that the operational noise cancellation data constellation 17 is stored in the built-in HDD 16A of the PC 10. Therefore, it is not necessary to transmit, to the external data storage section D1, the specifying information that designates the external HDD 30 and its operational status. So the CPU 12 skips step S15 and goes to step S16. In step S16, the CPU 12 selects and obtains the operational noise cancellation data corresponding to the external HDD 30 and its operational status, from the operational noise cancellation data constellation 17 stored not in the external data storage section D1 but in the built-in HDD 16A. Other steps are identical to those of the information systems 2A and 2B.

As described above, according to the information system 1 of Embodiment 1, the operational noise cancellation program 16a is executed by the CPU 12 of the PC 10, and the operational noise cancellation data 34b is read from the external HDD 30, and thus cancelling of operational noise is performed. The operational noise cancellation data 34b is data having phase characteristics that cancel the operational noises of the HD section 34 and the cooling fan 42 in the external HDD 30, for example. The obtained operational noise cancellation data 34b is superimposed by the CPU 12 onto audio data of an application program or the like, and outputted from the speaker 28. Since the outputted operational noise cancellation data has phase characteristics that cancel out operational noises, operational noises are canceled out such as to be unlikely for a user to hear. Thereby, the user can focus on listening to the audio data, with the operational noise from the external HDD 30 being reduced.

When it is detected that the operational status of the external HDD 30 is changed (YES in step S21, YES in step S23), the identification information 34a and the operational noise cancellation data 34b according to the changed operational status are newly read from the HD section 34.

In this way, the operational noise cancellation data, which is optimized according to differences in the operational noise depending on distinctions in the operational status of the external HDD 30—for example, the access state—writing, reading, or idling—of the HD section 34, is read, and thereby canceling of operational noise is performed.

According to Embodiment 2, the operational noise cancellation program (1) 16a is executed by the CPU 12 of the PC 10, and the operational noise cancellation program (2) 34c is executed by the MPU 44 of the external HDD 30. In the external HDD 30, the MPU 44 transmits the identification information 34a and the operational status to the PC 10, in response to completion of booting and change in the operational status being detected by the operational noise cancellation program (2) 34c. In the PC 10, according to the identification information 34a and the operational status, which are received by the operational noise cancellation program (1) 16a, the corresponding operational noise cancellation data is selected from any of the operational noise cancellation data constellations 17, 72, and 92.

The operational noise cancellation data constellation 72 is stored in the LAN-connected external data storage unit 70. Thereby, the operational noise cancellation data constellation 72 is concentratedly stored in and managed by the external data storage unit 70. In addition, the amount of data to be stored in the built-in HDD 16B of the PC 10 is reduced, and the load in managing the operational noise cancellation data is reduced.

The operational noise cancellation data constellation 92 is stored in the data storage site 90 connected to the Internet 80. Therefore, if the data storage site 90 is a site run by a vendor who provides the external HDD 30, the operational noise cancellation data constellation 92 is updated, as needed, according products released on the market. Thereby, prompt response to the released product is realized.

The PC 10 is configured with an information processing device, and the external HDD 30 is configured with a peripheral device. The CPU 12 executing the process in step S14 of Embodiment 2 (FIG. 6) is configured with a device designating section, and the CPU 12 executing the process in step S16 of Embodiment 2 (FIG. 6) is configured with a data obtaining section. The CPU 12 and the audio output control section 20, which execute the processes in steps S17 and S19 of Embodiments 1 and 2 (FIGS. 2 and 6), are configured with an operational noise canceling section. In Embodiment 1, the CPU 12 executing the process in step S13 is configured with a device designating section and a data obtaining section. The external HDD 30 includes a storage section as a component, and the disk drive sections (HD sections) 34 and 34A are configured with storage disk sections. The identification information 34a is an example of first identification information. The CPU 12, which executes the processes in steps S11 and S13 of Embodiments 1 and 2, the process in step S13A of Embodiment 2, and the process in step S11A of Embodiment 2 (FIGS. 2 and 6), is an example of a reading section. The external data storage section 70 and the data storage site 90 are examples of an external storage section. The LAN 60 and the Internet 80 are examples of a network. The operational status is an example of second identification information.

It should be noted that the present invention is not limited to the above-described embodiments, and numerous other modifications and variations can be devised without departing from the scope of the invention.

For example, although, in the embodiments of the present invention, the PC 10 has been described as an example of an information processing device, a television device or another AV device may be adopted as an information processing device. Further, although the external HDD 30 is described as an example of a peripheral device, any peripheral device that emits operational noise in a DVD player or other information device can be similarly adopted.

Further, although, in the embodiments of the present invention, the peripheral device includes the HD section 34 and the cooling fan 42, the present invention is not limited thereto. The present invention is similarly applicable to a case where the peripheral device is furnished with the one or the other, or to a case where the peripheral device has three or more operational noise emitting sources.

Further, although embodiments in which a single external HDD 30 as a peripheral device is connected to the information processing device have been described, the present is not limited thereto. The present invention is similarly applicable to a case where a plurality of peripheral devices each emitting operational noise are connected to the information processing device.

When a number of items of equipment emitting operational noise are operated within a peripheral device, or when a plurality of peripheral devices are connected to the information processing device, information indicating the type of operating equipment or device may be included in the operational status, and operational noise cancellation data may be selected according to the type of operating equipment or device.

The present invention is applicable to a case where operational noise cancellation data is provided as data for canceling composite operational noise in which operational noises of a plurality of devices are mixed, and to a case where operational noise cancellation data is provided for each of operational noises emitted from individual devices. In the latter case, the plurality of cancellation data may be superimposed.

In Embodiments 1 and 2, on the assumption that the data to be subjected to data processing includes audio data of a recorded television program or the like, the operational noise cancellation data is superimposed onto the audio data and outputted. In the present invention, however, it is not always necessary to superimpose the operational noise cancellation data onto the audio data. Even if the data to be subjected to data processing includes no audio data, or audio data is outputted from a speaker system (not shown) different from that for the operational noise cancellation data, it is possible to cancel operational noise. That is, the functions and effects resolving the issues of the present invention may be exhibited without superimposing the operational noise cancellation data on the audio data.

While the invention has been described in detail, the foregoing description is in all aspects illustrative and not restrictive. It will be understood that numerous other modifications and variations can be devised without departing from the scope of the invention.

What is claimed is:

1. An information system including an information processing device having an audio output function, and a peripheral device connected to the information processing device, wherein
the information processing device comprises:
a device specifying section for designating the peripheral device;
a data obtaining section for obtaining, based on designation results from the device specifying section, operational noise cancellation data being audio data for cancelling operational noise emitted from the peripheral device; and
an operational noise canceling section for outputting, by means of the audio output function, the operational noise cancellation data obtained by the data obtaining section.

2. The information system according to claim 1, wherein:
the peripheral device includes a storage section; and
the operational noise cancellation data includes audio data for canceling operational noise from the storage section.

3. The information system according to claim 1, wherein:
the peripheral device includes a cooling fan; and
the operational noise cancellation data includes audio data for canceling operational noise and/or wind noise from the cooling fan.

4. The information system according to claim 1, wherein:
the peripheral device has first identification information for identifying the peripheral device; and
the device specifying section includes a reading section for reading the first identification information from the peripheral device, and designates the peripheral device based on the first identification information.

5. The information system according to claim 1, wherein:
the information processing device or the peripheral device stores a plurality of items of operational noise cancellation data; and
the data obtaining section includes a selection section for selecting, from the plurality of items of operational noise cancellation data, operational noise cancellation data corresponding to operational noise emitted from the peripheral device.

6. The information system according to claim 1, wherein the data obtaining section includes a selection section for selecting, from an external storage section storing a plurality of items of operational noise cancellation data, via a network, operational noise cancellation data corresponding to operational noise emitted from the peripheral device.

7. The information system according to claim 4, wherein:
the reading section obtains, from the peripheral device, second identification information for identifying the operational status of the peripheral device; and
the data obtaining section selects, based on the first and second identification information, operational noise cancellation data corresponding to operational noise emitted from the peripheral device.

8. The information system according to claim 7, wherein:
the peripheral device includes a storage section; and
the second identification information is information identifying the state of access to the storage section.

9. For an information system including an information processing device having an audio output function and a peripheral device connected to the information processing device, a computer-readable non-transitory storage medium storing a program for causing a processor of the information processing device to execute the steps of:
obtaining, from the peripheral device, first identification information for identifying the peripheral device;
obtaining, based on the first identification information, operational noise cancellation data as audio data for canceling operational noise emitted from the peripheral device; and
outputting, by means of the audio output function, the obtained operational noise cancellation data.

10. The computer-readable non-transitory storage medium according to claim 9, wherein the operational noise cancellation data obtaining step that the storage medium causes the processor to execute includes a substep of selecting, from a plurality of items of operational noise cancellation data stored in the information processing device or the peripheral device, operational noise cancellation data corresponding to the first identification information.

11. The computer-readable non-transitory storage medium according to claim 9, wherein the operational noise cancellation data obtaining step that the storage medium causes the processor to execute includes substeps of:
accessing, via a network, an external storage section storing a plurality of items of operational noise cancellation data; and
selecting, from the external storage section, operational noise cancellation data corresponding to the first identification information.

12. The computer-readable non-transitory storage medium according to claim 9, wherein the program causes the processor of the information processing device to further execute the steps of:
causing a processor of the peripheral device to detect a change in the operational status of the peripheral device;
causing the processor of the peripheral device to transmit to the information processing device, when change in the operational status is detected, second identification information for identifying the changed operational status; and
obtaining the second identification information; wherein
the operational noise cancellation data obtaining step is a step of obtaining operational noise cancellation data for canceling operational noise from the peripheral device, based on the second identification information as well as the first identification information.

13. For an information system including an information processing device having an audio output function and a peripheral device connected to the information processing device, an operational noise canceling method to be executed by a processor of the information processing device, the method comprising the steps of:
obtaining first identification information identifying the peripheral device;
obtaining, based on at least the first identification information, operational noise cancellation data as audio data for canceling operational noise emitted from the peripheral device; and
outputting, by means of the audio output function, the obtained operational noise cancellation data.
